(19) United States
(12) Patent Application Publication
(10) Pub. No.: US 2019/0056960 A1
(43) Pub. Date: Feb. 21, 2019

(54) ONLINE DESKTOP OPERATING SYSTEM

(71) Applicant: William B. Potter, Greeneville, TN (US)

(72) Inventor: William B. Potter, Greeneville, TN (US)

(21) Appl. No.: 15/679,481

(22) Filed: Aug. 17, 2017

(51) Int. Cl. G06F 9/44; G06F 9/445; G06F 9/455; H04L 29/08

(52) U.S. Cl. CPC G06F 9/4445; G06F 9/44505; H04L 67/34; H04L 67/025; G06F 9/45558

(57) ABSTRACT

An online virtual computer system provides a browser-accessible virtual computer via the Internet. The virtual computer appears to the user to have a hard drive with selected capacity, a selected type of processor, RAM of selected size, and a selected virtual operating system. In a preferred embodiment, the virtual hardware and software specifications are selected by the user during a setup procedure. Because the virtual machine is always up-to-date with the latest hardware and software, the system relieves the user from concern about computer components becoming obsolete. Thus, the user does not have to worry about upgrading to a new computer and moving the user's data over to a new computer.

### FIELD

This invention relates to the field of computer operating systems. More particularly, this invention relates to an online virtual operating system.

### BACKGROUND

As computer technology improves, the data processing speeds and data storage capacities of computer systems are constantly increasing. Software developers are constantly providing upgraded software to take full advantage of the hardware improvements. Thus, hardware improvements push software improvements and visa-versa.

As a result of the continuous improvements in computer technology, the computer user must periodically made expensive upgrades of computer hardware to keep up. Without such hardware upgrades, the user's computer becomes outdated and unable to run the latest software. Upgrades of data storage hardware generally require transferring user data from the old storage device to the new storage device. Such transfers can be troublesome and time consuming, especially for inexperienced computer users.

What is needed, therefore, is a virtual computer system that is always maintained with up-to-date hardware and software, which is accessible via the Internet using a computer that need not have the most up-to-date hardware and software.

### SUMMARY

The above and other needs are met by an online virtual operating system that provides a browser-accessible virtual computer via the Internet. The virtual computer appears to the user to have a hard drive with selected capacity, a selected type of processor, RAM of selected size, and a selected operating system. In a preferred embodiment, the virtual hardware and software specifications are selected by the user during a setup procedure. Because the virtual machine is always up-to-date with the latest hardware and software, the system relieves the user from concern about computer components becoming obsolete. Thus, the user does not have to worry about upgrading to a new computer and moving the user's data over to a new computer.

In a preferred embodiment, the user sets up the virtual computer's specifications by selecting the desired type of operating system and the amount of storage needed for saving files, such as pictures, music files, games, game saves, and computer programs. The user can also select the amount of RAM and the type of processor for their virtual computer.

During the set up procedure, the user selects whether the virtual computer is to be accessible on any network connection or only through the IP address for the user's home network. If the user selects the user's network IP address, the virtual computer will only allow connection from that Internet connection. If the user selects to connect from anywhere, the user can connect to the virtual computer from anywhere they wish. The user can also set the virtual computer to only accept connections from certain “white listed” locations, such as a friend's house. If a company has more than one location, they can allow connection from all locations, while preventing connections from outside the company's network. This makes hacking more difficult, as no connection to the virtual computer will be allowed from any network IP address that is not on the white list.

After the user has selected the desired computer specifications, the system provides a:
Public DNS (IPV4) Address, which looks like a web URL address (i.e., Server1143.US1.Domain.com). This is the public hostname of an instance, which resolves to the public IP address or elastic IP address.
IPV4 Public Address, which is an IP Address (i.e., 173.149.63.2) that allows the user to connect to the virtual computer via a browser, a desktop program, Remote Desktop Protocol (RDP), or other ways as long as the user has an Internet connection.
Computer Log Number (Instance ID), which is a unique ID given to the virtual computer. If there are problems with the connection to the virtual computer, or if there is a need for troubleshooting, the technical support person can more easily identify the virtual computer.
Private DNS, which indicates the location of the virtual hard drive on which all of the user data (pictures, documents, files and other important data) are stored. This is the private, internal hostname that resolves to the instance's private IP address. (i.e., (Private IP)—us1.domain.com)
Private IP, which is an IP address linked to a physical hard drive or other physical storage device associated with the physical machine from which the virtual computer is being accessed. Using this address, the user's online virtual hard drive can be linked to the storage device of the physical computer as a network drive, so that files can be uploaded and downloaded to and from the online virtual hard drive.
Connect Code, which is a code used when logging in for the first time from a new device or new network location.

Once the user has set up the specifications of the virtual computer and received the above described information, the user can connect to the virtual computer. The connection can be made using any one of several ways, although only one connection to the virtual computer is allowed at a time. If a second login is made from a second device or location, the first connection will be terminated and a message window will appear at the terminated device indicating that the disconnection was due to a second login from another location or device.

The ways by which a user can connect to the virtual computer include:
Browser. The user enters the web address assigned to the virtual machine in a browser, along with the user's Public IP or Connect Code. When the Public IP or Connect Code is confirmed, the user enters their User Name and Password. Upon validation, the user has access to their online virtual computer.
Desktop Program. Using a program that has been downloaded to a physical computer (not an online virtual computer), the user enters the user's Public IP or Connect Code. When the Public IP or Connect Code is confirmed, the user enters a User Name and Password. Upon validation, the user has access to the virtual computer.
Remote Desktop Protocol (RDP). As the virtual computer is running from a server, the user can connect to it using RDP. Through RDP, the user enters the Public IP to gain access to the virtual computer, which will prompt the user for a User Name And Password.
Boot File. The user has an option to download an ISO or USB boot file to a USB drive or compact disc (CD). Using the USB drive or CD, the user can boot directly to the virtual computer without having to enter login credentials, so as long as there is a Wi-Fi or Ethernet connection. Virtual computers having different specifications can be set up to boot from different USB drives or CDs. In some embodiments, the boot file may be a PXE boot file.

Some embodiments of the invention provide an online virtual computer system that includes a server computer, a wide area communication network such as the Internet, and a low-performance user computer. The server computer may include a user data storage device, an operating system database, and a user database. The user data storage device has a first amount of data storage capacity for storing user data files comprising one or more of image files, video files, music files, and gaming files. The operating system database contains a plurality of virtual operating systems, each simulating a data processor having at least a first processing speed and at least a first amount of processing memory. The user database contains user account information. The low-performance user computer is in communication with the server computer via the wide area communication network. The low-performance user computer includes a data processor having a second processing speed that is less than the first processing speed simulated by the virtual computer operating system. The low-performance user computer has a second amount of processing memory that is less than the first amount of processing memory simulated by the virtual computer operating system. The data processor of the low-performance user computer executes software to access the virtual operating system. The software may be a browser program, a desktop program, a remoted desktop protocol program, or a boot program.

In some embodiments, the second data processing speed of the low-performance user computer is 2.5 GHz or less and the first data processing speed of the simulated data processor is 2.5 GHz or more.

In some embodiments, the second amount of processing memory of the low-performance user computer is 500 MB or less and the first amount of processing memory of the simulated data processor is 64 GB or more.

In some embodiments, the user data storage device, the operating system database, and the user database implement Structured Language Query protocol.

In some embodiments, the first data processing speed, the first amount of processing memory, the first amount of data storage capacity, and the virtual operating system are user selectable.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein:

FIG. 1 depicts an online virtual operating system according to a preferred embodiment;

FIG. 2 depicts a process for implementing an online virtual operating system according to a preferred embodiment;

FIG. 3 depicts a process for setting up an online virtual operating system according to a preferred embodiment; and

FIG. 4 depicts an exemplary display screen showing virtual computer system setup parameters.

### DETAILED DESCRIPTION

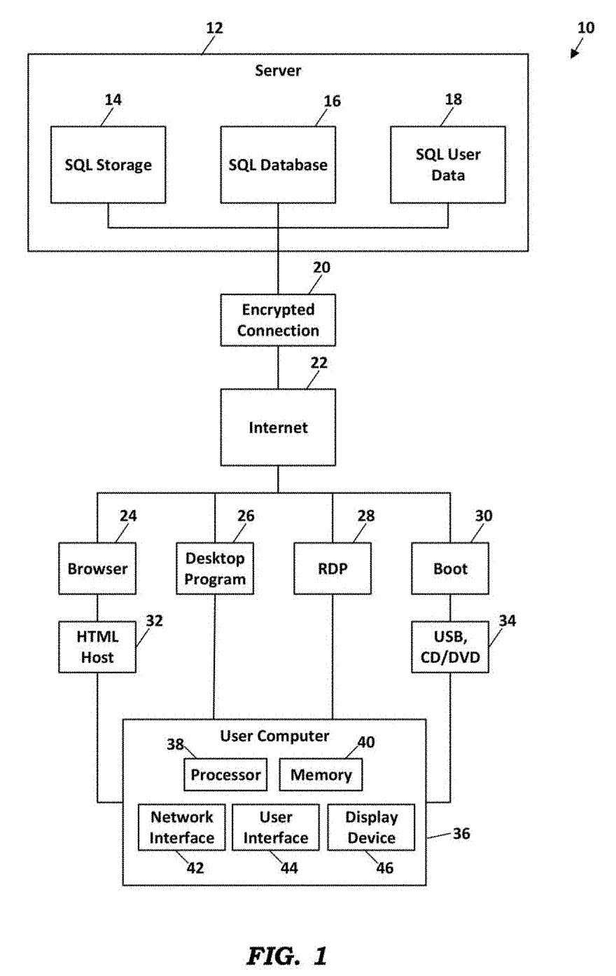

As shown in FIG. 1 a preferred embodiment of an online virtual operating system 10 includes a server computer 12 connected to the Internet 22 through an encrypted connection 20. The system 10 includes a user computer 36 that is also connected to the Internet 22. In general, the user computer 36 may be a basic device that includes a fairly low-speed processor 38 (such as 2.5 GHZ), a minimal amount of RAM 40 (such as 500 MB), a network interface device 42 (i.e., Ethernet or Wi-Fi), a user interface device 44 (i.e., keyboard, mouse, touchpad), and display device 46. Generally, an Internet connection speed of at least about 3 MB/sec should be available to the user computer 36. In some embodiments, the user computer 36 includes a CD/DVD drive or USB port 34 for loading a boot file.

The server computer 12 includes a Structured Query Language (SQL) data storage location 14, an SQL database 16, and an SQL user data storage location 18. The SQL storage location 14 contains files and programs saved by the user, such as image files, video files, audio files, game settings files, and document files. The SQL database 16 contains the virtual operating system. The SQL user data storage location 18 contains user data, such as the user's login credentials.

A server-side encrypted connection 20 is provided between the server 12 and the Internet 22. Generally, server-side encryption protects static data using encryption keys with strong multi-factor encryption. The server encrypts each object with a unique key. As an additional safeguard, the server encrypts the key itself with a master key that is rotated regularly. The server-side encryption typically uses 256-bit Advanced Encryption Standard (AES-256) to encrypt the user's data, which is one of the strongest block ciphers available.

A preferred embodiment of the system 10 provides four options through which the user computer 36 may access the server 12 to run the virtual computer operating system. In a first option, the virtual computer is accessed via an HTMLS host 32 and browser program 24. Because the HTMLS client is a web application, the user computer 36 is not tied any one device or location. As long as the user computer 36 has access to a web browser, the user computer 36 can access the virtual computer. In a second option, the virtual computer is accessed via a desktop program 26 that is running on the user computer 36. The desktop program 26 is programed to connect directly to the SQL database 16 to provide an easy connection. In a third option, the virtual computer is accessed via Remote Desktop Protocol (RDP) 28, which requires the user to enter the domain or IP address of the server 12 and a user name and password. In a fourth option, the virtual computer is accessed via a boot program 30 stored on a storage device 34, such as a CD/DVD disk or USB flash drive. In some embodiments, the user downloads the boot file from a website.

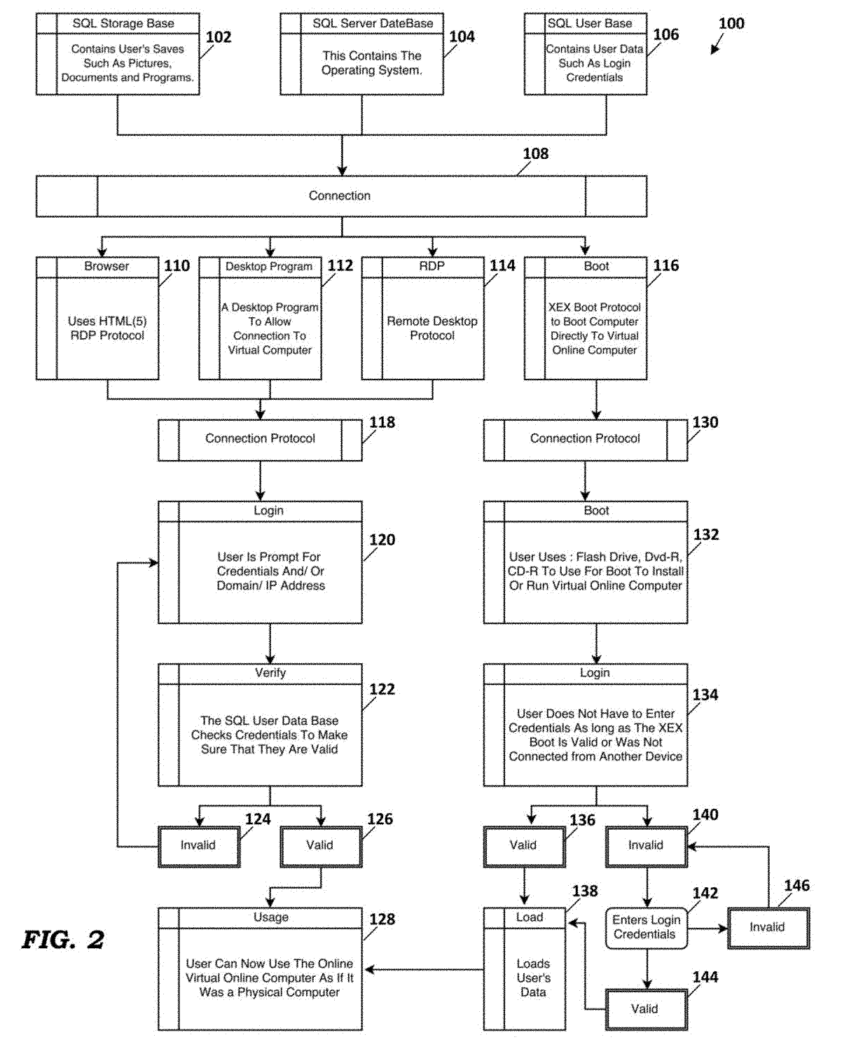

A preferred embodiment of a process for implementing the online virtual operating system is depicted in FIG. 2. A connection is established between the server 12 and the user computer 36 (step 108), such as through the Internet 22 using a connection protocol (steps 118 or 130). The connection may be established via the browser 24, such as using HTML(5) RDP (step 110), via the desktop program 26 (step 112), via RDP 28 (step 114), or via the boot program 30 (step 116)

If connecting using the browser, desktop program, or RDP, the user is prompted for user credentials and/or a domain/IP address (step 120). The SQL user data storage location 18 is accessed to verify the validity of the user credentials (step 122). If the credentials are valid (step 126), the user computer is provided access to the virtual computer (step 128). At this point, the operating system windows displayed on the user computer are generated by the virtual computer, and it appears to the user that the user computer is the virtual computer.

If connecting using the boot program, the user computer 36 is booted from the boot program on the storage device 34 (step 132). In this case, as long as the boot file is valid and there is no existing connection from another user computer, there is no need to enter user credentials to complete the login procedure (step 134). If the boot is valid (step 136), the user's data is accessed from the SQL data storage location 14 (step 138) and the user computer is provided access to the virtual computer (step 128). If the boot is not valid (step 140), the user enters the login credentials (step 142). If the login credentials are valid (step 144), the user's data is accessed from the SQL data storage location 14 (step 138) and the user computer is provided access to the virtual computer (step 128). If the login credentials are not valid (step 146), the user may reenter corrected credentials (step 142).

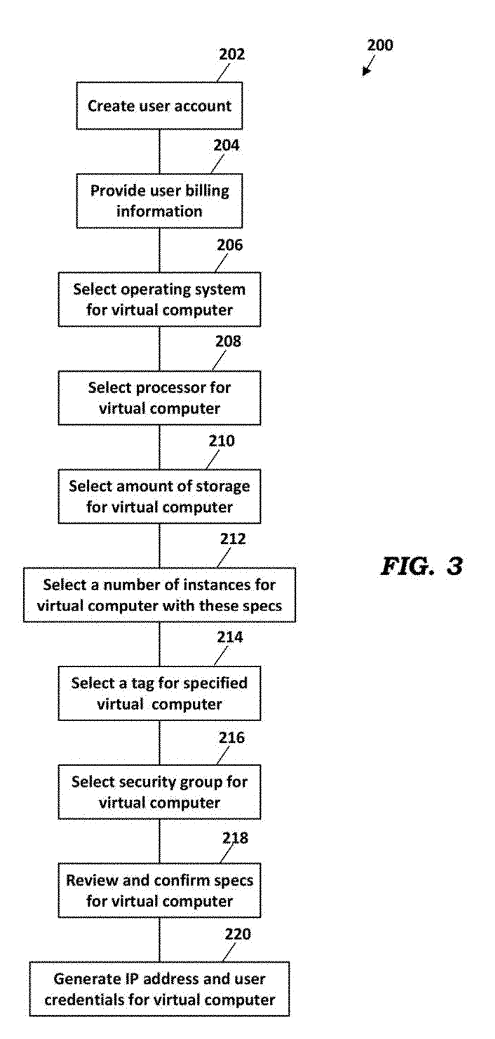

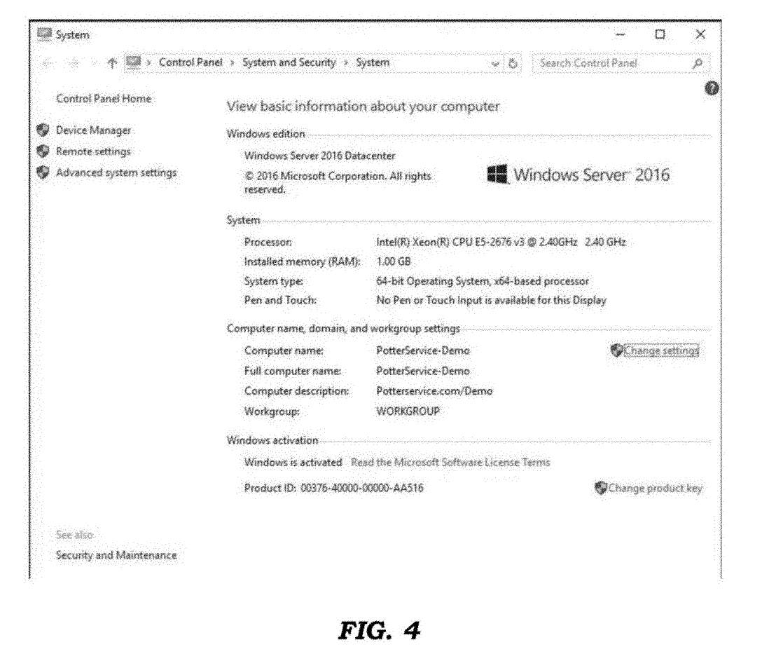

As shown in FIG. 3, preferred embodiments of the invention provide an online process 200 for setting up the virtual computer on the server 12. This involves creating a user account (step 202) and providing user billing information (step 204). The user then selects a preferred operating system for the virtual computer, such as Windows 10 (step 206). The user also selects the type of processor and RAM size for the virtual computer (step 208) and its data storage capacity (step 210). For example, the user may select a 1 vCPUs, 2.5 GHz, Intel Xeon Family processor having 1 GB of memory. An example of a setup screen for entering the information for steps 208 and 210 is depicted in FIG. 4. The user also selects how many instances of the virtual computer are to be set up with the same specifications (step 212). In some embodiments, the user may set up a “tag” that serves as the user's virtual password (step 214). The user also selects the security group, which specifies whether the computer will be able to connect from outside of the user's home network, and if so, from where (step 216). Prior to payment, the user reviews the specifications entered for the virtual computer and confirms all is correct (step 218). Upon confirmation and payment, the server 12 generates an IP address for the virtual computer and sets up the user's credentials for access to the virtual computer (step 220).

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An online virtual computer system comprising:
a server computer comprising:
a user data storage device having a first amount of data storage capacity for storing user data files comprising one or more of image files, video files, music files, and gaming files;
an operating system database containing a plurality of virtual operating systems, each virtual operating system simulating a data processor having at least a first processing speed and at least a first amount of processing memory; and
a user database containing user account information;
a wide area communication network to which the server computer is connected;
a low-performance user computer in communication with the server computer via the wide area communication network, the low-performance user computer comprising:
a data processor having a second processing speed that is less than the first processing speed simulated by the virtual computer operating system;
a second amount of processing memory that is less than the first amount of processing memory simulated by the virtual computer operating system; and
software executed by the data processor to access the virtual operating system, the software comprising one or more of:
a browser program;
a desktop program;
a remoted desktop protocol program; and
a boot program.

2. The online virtual computer system of claim 1 wherein the second data processing speed is 2.5 GHz or less and the first data processing speed is greater than 2.5 GHz.

3. The online virtual computer system of claim 1 wherein the second amount of processing memory is 500 MB or less and the first amount of processing memory is 64 GB or more.

4. The online virtual computer system of claim 1 wherein the user data storage device, the operating system database, and the user database operate based on Structured Language Query protocol.

5. The online virtual computer system of claim 1 wherein the first data processing speed is user selectable.

6. The online virtual computer system of claim 1 wherein the first amount of processing memory is user selectable.

7. The online virtual computer system of claim 1 wherein the first amount of data storage capacity is user selectable.

8. The online virtual computer system of claim 1 wherein the virtual operating system is user selectable.
